(19) United States
(12) Patent Application Publication
(10) Pub. No.: US 2016/0238397 A1
(43) Pub. Date: Aug. 18, 2016

(54) NAVIGATING TO COMFORTABLE AND SAFE PARKING

(71) Applicant: International Business Machines Corporation, Armonk, NY (US)

(72) Inventors: Maria Teresa Caira, Rome (IT); Giuseppe Longobardi, Castellammare di Stabia (NA) (IT); Maria Elena Massino, Rome (IT)

(21) Appl. No.: 14/623,753

(22) Filed: Feb. 17, 2015

(51) Int. Cl. G01C 21/34

(52) U.S. Cl. CPC G01C 21/34

(57) ABSTRACT

One or more processors receive a geographic destination. One or more processors determine one or more parking spaces within a distance of the geographic destination. One or more processors assign a ranking order for the one or more parking spaces based on one or both criteria of comfort and safety. One or more processors provide navigation to the one or more parking spaces. The ranking order for the one or more parking spaces determines an order of arrival at any one parking space of the one or more parking spaces.

### BACKGROUND OF THE INVENTION

The present invention relates generally to the field of global positioning system (GPS) navigation, and more particularly the use of GPS to facilitate parking with comfort and safety.

GPS navigation systems are becoming more and more common in the modern world. GPS receivers are standard equipment in millions of devices, from phones to automobiles, sold worldwide. GPS navigation systems provide real-time route directions to a user through regular communications between a GPS receiver and orbiting satellites. A typical example is a GPS navigation system installed in a modern vehicle or, alternatively, bought separately and placed on the vehicle dashboard. The user enters the destination to which they wish to travel and the GPS navigation system provides turn-by-turn instructions during the trip. Once the user (driver) reaches their destination, it may be challenging to find parking for the vehicle while they stay at the destination.

### SUMMARY

Embodiments of the present invention provide a method, system, and program product for navigating to a parking space. One or more processors receive a geographic destination. One or more processors determine one or more parking spaces within a distance of the geographic destination. One or more processors assign a ranking order for the one or more parking spaces based on one or both criteria of comfort and safety. One or more processors provide navigation to the one or more parking spaces, wherein the ranking order for the one or more parking spaces determines an order of arrival at any one parking space of the one or more parking spaces.

### BRIEF DESCRIPTION OF THE SEVERAL VIEWS OF THE DRAWINGS

FIG. 1 is a functional block diagram illustrating a parking navigation environment, in accordance with an exemplary embodiment of the present invention.

FIG. 2 illustrates operational processes of a parking program, on a computing device within the environment of FIG. 1, in accordance with an exemplary embodiment of the present invention.

FIG. 3 depicts a map schematic illustrating a potential output of a parking program, on a computing device within the environment of FIG. 1, in accordance with an exemplary embodiment of the present invention.

FIG. 4 depicts a block diagram of components of the computing device executing a parking program, in accordance with an exemplary embodiment of the present invention.

### DETAILED DESCRIPTION

There are known navigation systems that recognize a parking spot as the true destination for many GPS-guided trips. These navigation systems focus on factors such as the availability, cost, and distance of potential parking spots to a given destination. However, factors impacting trip comfort are also be affected by parking spot location. For example, on a cold day a car that has sat bathed in sunlight is often a more pleasant vehicle to get into and start than one that has sat in the shade. If the weather is quite hot, the exact opposite situation may exist. Thus, parking a vehicle in the shade during a hot day makes the vehicle more pleasant to get in and start as opposed to a vehicle that was more exposed to the sun. In addition, factors impacting trip safety are often affected by parking spot location. For example, if a parking spot is arrived at or vacated from during the night the availability of adequate lighting may be a concern. In general, travelers concerned with comfort and safety during trips would benefit from GPS navigation systems that incorporate these factors into directions for not only driving, but also for locating parking spaces.

Embodiments of the present invention recognize that returning to a comfortable vehicle after a parking stay is desirable. Embodiments of the present invention provide a method to navigate to parking spots whereby factors governing the comfort of the vehicle upon return are considered. Embodiments of the present invention recognize that parking location on many trips will impact trip safety. Embodiments of the present invention provide a method to navigate to parking spots whereby factors governing trip safety are considered.

The present invention will now be described in detail with reference to the Figures.

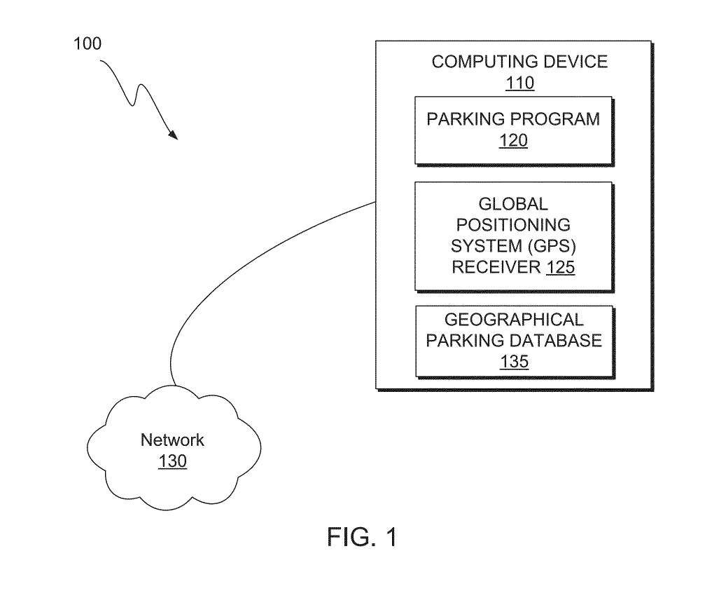

FIG. 1 is a functional block diagram illustrating a parking navigation environment, generally designated 100, in accordance with one embodiment of the present invention. Parking navigation environment 100 includes computing device 110 connected over network 130. Computing device 110 includes parking program 120, GPS receiver 125, and geographical parking database 135.

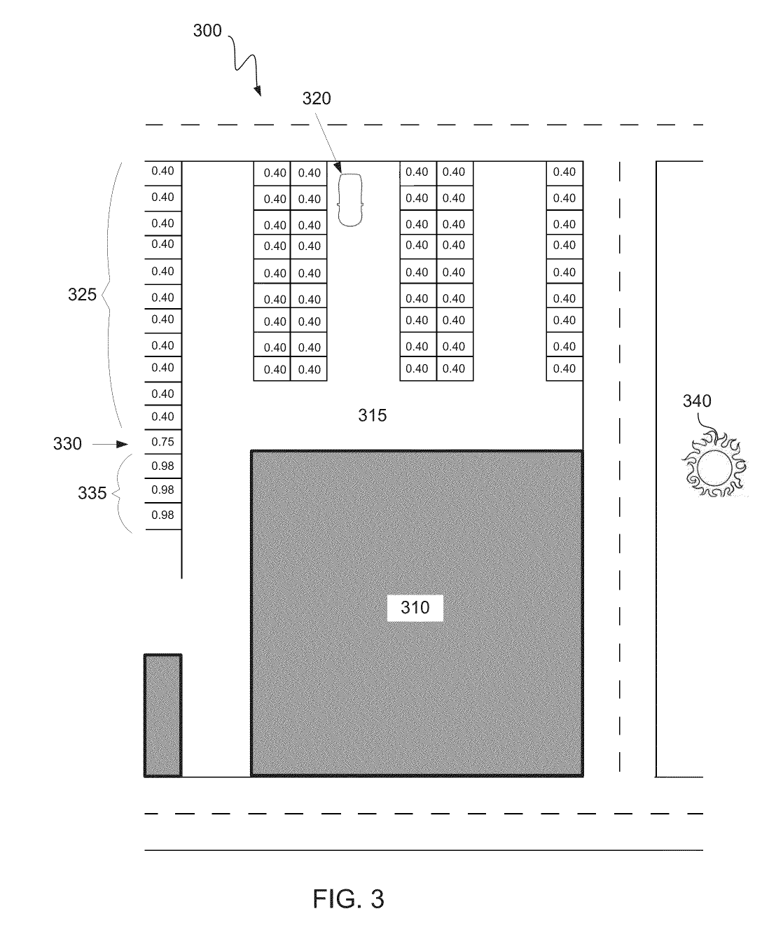

In various embodiments of the present invention, computing device 110 is a computing device that can be a standalone device, a server, a laptop computer, a tablet computer, a smartphone, a netbook computer, a personal computer (PC), or a desktop computer. In another embodiment, computing device 110 represents a computing system utilizing clustered computers and components to act as a single pool of seamless resources. In general, computing device 110 can be any computing device or a combination of devices with access to GPS receiver 125 and geographical parking database 135 and is capable of executing parking program 120. Computing device 110 may include internal and external hardware components, as depicted and described in further detail with respect to FIG. 3.

In this embodiment, parking program 120 and geographical parking database 135 are stored on computing device 110. However, in other embodiments, one or both parking program 120 and geographical parking database 135 may be stored externally and accessed through a communication network, such as network 130. Network 130 can be, for example, a local area network (LAN), a wide area network (WAN) such as the Internet, or a combination of the two, and may include wired, wireless, fiber optic or any other connection known in the art. In general, network 130 can be any combination of connections and protocols that will support communications between computing device 110, parking program 120, GPS receiver 125, and geographical parking database 135, in accordance with a desired embodiment of the present invention.

In some embodiments, parking program 120 uses maps and meta-data contained in geographical parking database 135 to weigh factors involving vehicle comfort, which depend on parking space selection. For example, parking program 120 will compute which parking spots near a destination will be shady for some or all of an anticipated visit and which parking spots will have little shade during the period of visitation. If the weather is expected to be cold during the anticipated visit, then the parking spaces that will be sunny will be given higher weight than those that will be in the shade because the warming effect of the sun is welcome during cold winter days. On the other hand, if the weather is expected to be warm during the anticipated visit, then shaded parking spaces will be given higher weight than sunbaked parking spaces because vehicles that sit in the sun on warm days are typically less pleasant to occupy compared to vehicles that have sat in the shade. In some embodiments, the source of shade will contribute to parking spot selection. For example, the shade of a building is typically preferred over the shade of a tree if one considers the impact on vehicle hygiene. Material such as sap, leaves, and bird waste may be deposited on a vehicle parked under a tree whereas such material is less likely to find its way onto a vehicle parked in the shade of a building.

In various embodiments, parking program 120 uses maps and meta-data contained in geographical parking database 135 to weigh factors involving safety, which depend on parking space selection. For example, parking spots that are well lit will be given more weight for a trip that involves arriving or departing during nighttime. In one embodiment, parking spaces for handicapped individuals are included in geographical parking database 135 and are given a high weight by parking program 120 if a handicapped passenger or driver is making the trip. Alternatively, such parking spaces are not included as an option if no one in the vehicle is handicapped. Likewise, if the vehicle requires or can use specialized parking (as would be the case if it were, for example, a motorcycle or a large truck), parking program 120 gives a higher weight to such parking spaces. In some embodiments, parking program 120 assigns weights (i.e. values) and navigates a vehicle to parking spots the vehicle can actually use that have the highest weighted value.

Geographical parking database 135 is not limited to maps and meta-data. Geographical parking database 135 also contains data from police databases, which is factored into parking spot weight. Thus, parking spots in areas that have seen more crime than other parking areas will be given a lower weight. In one embodiment, geographical parking database 135 contains not only the crime statistics for potential parking spots near the destination, but also crime statistics for the area to be traveled between the potential parking spots and the destination. In this embodiment, travelers to major events such as sporting events or concerts, who will likely park far away from the event, are navigated to parking spots that provide a safe path between the event and the parking space.

In some embodiments, geographical parking database 135 is constantly updated with weather forecasts of the destination location and the route being navigated. Thus, shade weight for parking spots is deemphasized by parking program 120 if the vehicle will be parked at the destination on a cloudy or rainy day. In this embodiment, parking spots close to the destination with a path allowing shelter will be heavily weighted if, for example, rain is forecasted. In one embodiment, parking program 120 reminds the user to bring an umbrella when rain is expected. In one embodiment, parking program 120 warns the vehicle operator of the high probability of traveling in severe weather or being stuck at the destination because of severe weather events such as heavy snowfall. For example, a severe winter storm typically causes the issuance of a severe winter storm warning. These severe winter storm warnings will typically indicate where the adverse weather will occur and when. Parking program 120 queries sources of weather data and analyzes whether the trip to the destination will be impacted. Based on this analysis, parking program 120 advises the vehicle operator on road conditions that may adversely affect the trip to and from the destination during a given time period.

In some embodiments, geographical parking database 135 includes preferences of repeat drivers and/or passengers. For example, a vehicle owned by a family will usually have a limited number of individuals who typically operate the vehicle. Custom, one-time information will be input into geographical parking database 135 for each operator. For example, parallel parking makes one repeat operator uncomfortable and unsafe. In that case, this preference is included in geographical parking database 135 and parking program 120 puts much less weight on parking spots requiring the ability to parallel park. On the other hand, another common repeat operator does not mind or even enjoys the challenge of parallel parking. In that case, this operators profile on geographical database 135 reflects this lack of trepidation and does not distinguish between parallel parking and angled parking.

In some embodiments, the individual operator profiles on geographical database 135 modulate weighting for any individual parameter. For example, a dark parking lot may be less threatening at night to one repeat operator of a vehicle so this operator profile will not be decrease the weight of an unlit parking spot even though the vehicle will arrive or depart at night. On the other hand, another repeat operator may be very uncomfortable in a dark, unlit parking lot so their profile reflects this concern and parking spots in lots without lighting will be decreased significantly in weight when arrival or departure occurs at night. Geographical parking database 135 is modulated by operator profiles in other embodiments as well. For example, an operator of a vehicle may not be interested in parking spots farther than, say, two hundred meters from the destination. In that case, only parking spots less than that distance from the destination will be navigated to by parking program 120. Note that it does not matter whether a vehicle has one operator or multiple operators in order to be capable of modulating geographical parking database 135. In some embodiments, however, parking program 120 asks for a choice of operator profile when more than one exists. When only one operator profile exists, parking program 120 assumes that that operator is always the operator driving and obeys that operator profile preferences by default.

As used herein for this exemplary embodiment of the present invention, “weight increase” or “weight decrease” and the like refer to parking spot weighting or ranking. In other words, parking program 120 determines a weighted value for parking spots based on an assessment of that parking spot, which is guided by a set of criteria. In some embodiments, each criteria contributes a weighted value and the sum of these weighted values reflects the overall weighted value of that parking spot. Therefore, the determined weighted value reflects the overall desirability of a parking spot in light of the criteria against which that parking spot is assessed.

In this embodiment, in general, the more a parking spot is predicted to experience a particular condition (as indicated by the criteria) the more the weighted value changes for that criteria. In some embodiments and scenarios, the greater the exposure of a parking space to a particular environmental condition, for example and amount of shade exposure, the more that exposure is reflected in the weighted value. For example, if an amount of sun exposure is indicated by the criteria, and sun exposure has been indicated to be desirable by the criteria, then a change in the amount of sun exposure for a given parking spot (also herein called “sunniness”) results in a corresponding change in the weighted value for that parking spot. In some embodiments, the amount of exposure is reflected as a simple ratio of exposure over time. In other embodiments, this is reflected on a non-linear scale, for example a logarithmic scale. In some embodiments, parking program 120 uses knowledge of physical systems and the vehicle (to be parked) to further refine weighted values. For example, parking program 120 uses thermal diffusion rates in combination with known characteristics of a vehicle to determine that a second parking spot is more desirable than a first parking spot. In this example, the first parking spot and second parking spot are across from one another (i.e., facing one another) in a single parking row of a parking lot.

In this example, parking program 120 determines that, for the first parking spot, the sun will be shining through a front window and onto black leather seats. However, parking program 120 determines that, for the second parking spot, the sun will be shining through a tinted rear window, thereby shielding the black leather seats from the sun. Parking program 120 determines a total estimated amount of heat likely to enter the vehicle (via a determined amount of entering sunlight) for both parking spots, and the rate of cooling of that vehicle based on the rate of thermal diffusion for that vehicle (i.e., the rate that heat leaves the interior of the car). Based on these results, parking program 120 determines that the second parking spot is more desirable than the first parking spot even though both will experience identical exposure to the sun.

In some embodiments, higher weighted values indicate more desirable parking spots. In other embodiments, lower weighted values indicate more desirable parking spots. For ease of understanding, in this embodiment, an increase in the “weight” of a parking spot means that the desirability of that parking spot has been increased. Likewise, a decrease in the “weight” of a parking spot means that the parking spot has become a less desirable place to park a vehicle. In various embodiments, numeric values are used to rank parking spots. In other embodiments, bivalent logic is sufficient for parking spot ranking (i.e. sunny=“true” and shady=“false” or vice versa). Such bivalent logic designations will facilitate data outputs that are visualized by, for example, colors in some embodiments. For example, a sunny parking spot will be color coded red and a shady parking spot will be color coded green in various embodiments. In one embodiment, both numeric values and bivalent logic designations will be used. For example, bivalent logic are used to indicate sunny/shady designations and numbers used to rank parking spots for other parameters. Regardless of how parking spot rankings are computed, the overall logic for all embodiments of the present invention remains the same, which is to guide vehicle operators to the most preferred parking spots near their destination.

GPS satellites circle the Earth and transmit signal information to earth. GPS receiver 125 takes a portion of this information (i.e., the signals from the GPS satellites that reach GPS receiver 125) and uses triangulation to calculate the vehicle exact location. Essentially, GPS receiver 125 compares the time a signal was transmitted by a satellite with the time it was received. The time difference tells GPS receiver 125 how far away the satellite is. GPS receiver 125 determines the two dimensional vehicle geographical position (latitude and longitude) of the vehicle and tracks its movement if GPS receiver 125 is locked on to the signal of at least three satellites. GPS receiver 125 sends the vehicle position to parking program 120, which then calculates other information, such as speed, bearing, track, trip distance, distance to destination, sunrise and sunset time.

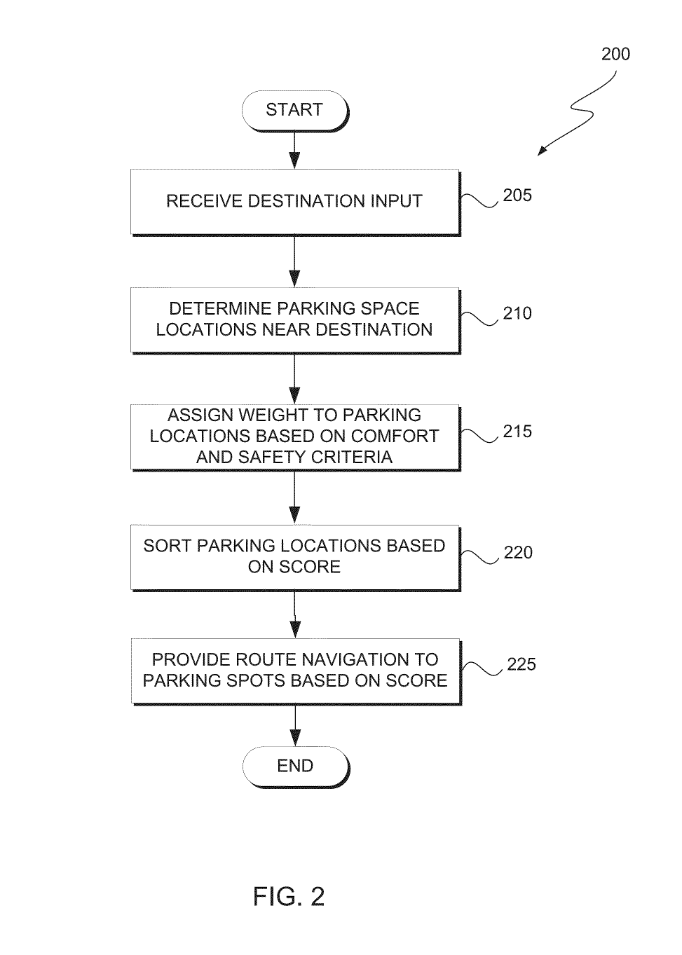

FIG. 2 illustrates operational processes, 200, of a parking program 120, on computing device 110 within the environment of FIG. 1, in accordance with an exemplary embodiment of the present invention.

In step 205, parking program 120 receives the destination input, which includes, but is not necessarily limited to, the coordinates for the geographical location of the destination, the start time for the trip, and the expected length of stay. In various embodiments where more than one operator of a vehicle exists, the identity of the current vehicle operator is queried by parking program 120 in order to draw on that operator's preferences in geographical parking database 135. In various embodiments, the destination geographical coordinates are input by the vehicle operator at the beginning of the trip. In other embodiments, the destination geographical coordinates will be input well before the beginning of the trip and saved by parking program 120 until the trip begins. In some embodiments, parking program 120 facilitates destination geographical coordinates input by maintaining a database of postal codes, as well as city, town, and street names, etc., either in parking program 120 or in geographical parking database 135. Thus, the operator may enter various incomplete destination data and parking program 120 will offer a narrow set of choices in order to facilitate data entry.

In some embodiments, the start time of the trip is indicated by the vehicle operator when the trip has actually started. In one embodiment, the vehicle operator merely touches a “go” button on a touch screen and a destination parking spot estimated time of arrival is calculated by parking program 120 after calculating a navigation route. In another embodiment, the movement of the vehicle, which is determined by parking program 120 from monitoring satellite data received from GPS receiver 125, serves to indicate the beginning of the trip. Subsequently, parking program 120 determines parking space weights and determines the navigation route to the highest ranked parking spot.

In some embodiments, the expected length of stay is entered prior to arrival at the destination. The expected length of stay is used by parking program 120 to augment the weighting of the destination parking spots. For example, if a sunny parking spot is desirable because of cold weather, the parking spots that will enjoy the most sun over that period will not be the preferred parking spot if the parking spots are in the shade for a significant period of time just prior to vehicle anticipated departure. In this embodiment, the highest “sunniness” weight will be given to the vehicles that will spend the longest time in the sun for a specified period of time prior to departure. Likewise, shady parking spots on hot days will receive the maximum weight if the parking spots are in shade for the longest time just prior to anticipated vehicle departure.

The expected or anticipated length of stay will also affect other parking spot weight parameters. In one embodiment, if the departure time is anticipated to occur during the daytime, the weight given the parking spot because of lighting will be significantly diminished compared to the case when an anticipated departure is expected to occur near nightfall or after dark. Likewise, the path between a distant major event like a concert or sporting event may be statistically safe during the day according to police databases accessed by geographical database 135. Many areas, for example, are mainly dangerous at night. Thus, if the anticipated departure time for such a scenario is well within daylight hours, the weight of a parking spot requiring travel by foot along such a pathway will be less diminished compared to departure times occurring close to nightfall or after dark.

In step 210, parking program 120 considers eligible parking spots near the destination geographical coordinates that are in geographical parking database 135. In one embodiment, parking spots are eligible if the vehicle operator or passenger status (and documentation) make them eligible such as the case for handicapped parking. In one embodiment, the type of vehicle will affect what parking spots are eligible. For example, a motorcycle will typically be eligible for any automobile parking plus any smaller spots expressly reserved for motorcycles. In another example, large trucks will be ineligible for parking spaces that cannot accommodate their large size. In one embodiment, an operator-set parameter for acceptable distance from the destination will eliminate parking spots further than that distance. In one embodiment, parking spots that are undesirable for other reasons as indicated by the vehicle operator profile may be eliminated (such as, for example, parallel parking spots).

In step 215, the eligible parking spots from step 210 are assigned a weight by parking program 120 based on customizable comfort and safety criteria from geographical parking database 135. In one embodiment, during a hot day parking spots that receive the longest period of shade just prior to the anticipated vehicle departure from the parking spots will be given more weight in the analysis. Likewise, parking spots that receive the longest period of sun just prior to the anticipated vehicle departure from the parking spots will be given more weight on a cold day. Weather forecast data available on geographical database 135 will also factor into the sun/shade weighting since the absence of direct sunshine typically diminishes shadows.

The calculation or simulation of shadows by parking program 120 starts with a determination of the sun azimuth and altitude at the time and location in question. The sun azimuth is the angle of the sun around the horizon, usually measured from the north increasing towards the east. The sun altitude is the angle between the sun and the horizon. Algorithms for determining sun azimuth and altitude for any given Earth latitude and longitude at any given time are well-known in the art and will not be further discussed here. Once the sun azimuth and altitude are known for the destination area, metadata from maps on geographical parking database 135 is used to determine the dimensions of shadow-casting objects such as buildings and trees, which surround the eligible parking spots. The shadows that are cast from such objects are then determined by calculations well known in the art and the parking spots that are shaded are differentiated from the parking spots that are in the sun. In some embodiments, parking program 120 queries a remote shadow simulation program and receives, in turn, shadow simulation data that is used to determine which parking spots near the destination will be sunny or not.

In various embodiments, safety factors surrounding the eligible parking spots will be considered by parking program 120 when assigning weighting to parking spots in step 215. For example, parking spots with lighting will have increased weighting, especially if the arrival or departing times are close to nightfall or at night. Map metadata such as the metadata available from GOOGLE or other map providers will be available on geographical parking database 135 allowing parking program 120 to determine the presence of lighting for many potential parking spots. In this embodiment, the weighting will be determined by the ratio of parking lights to parking spaces. Data from municipal databases will also be useful for determining the presence or absence of lighting as well as determining other useful information such as whether the parking spots are available to the public.

In step 220, parking program 120 sorts the weighted parking spots from highest weight (most desirable) to lowest weight (least desirable) based on the customizable criteria set up by the vehicle operators. In one embodiment, the sorting function incorporates convenience considerations such as desirable parking spot clustering. In this embodiment, the highest weighted parking spots may not be sorted first if they stand alone or are surrounded by mostly low-weighted parking spots. Instead, parking spots that have a high weight and are close to numerous other high-weighted parking spots will be sorted higher than a parking spot that is more highly weighted than any of them, but is surrounded by undesirable spots or very few spots at all. In this embodiment, clusters will be identified and the weights of the parking spots averaged. The highest average weighted cluster will be navigated to first.

In step 225, parking program 120 uses GPS receiver 125 to navigate the vehicle operator to the number one sorted parking spot. In some embodiments, parking program 120 accommodates travel time delays in step 225, which affects the parking spot rankings. In this embodiment, steps 215 and 220 is repeated numerous times before the arrival of the vehicle to the highest ranked parking spot, which will be the result of the latest iteration of steps 215 and 220. In some embodiments, parking program 120 will navigate the vehicle operator to the highest-average-weighted cluster and communicate the ranking of the parking spots in that cluster.

If the first parking spot that parking program 120 directs the vehicle operator to is occupied, then parking program 120 navigates the vehicle operator to the next highest ranked parking spot. If the next highest ranked parking spot is occupied, the operator is directed to the next highest ranked spot. In several embodiments, parking program 120 will continue directing the operator until the vehicle has successfully parked or the operator shuts off parking program 120. In one embodiment, parking program 120 ceases to direct the vehicle operator to additional parking spots when the vehicle is in a parking space it was navigated to and the engine is off. In another embodiment, parking program 120 ceases to direct the vehicle operator to additional parking spots when the vehicle operator or occupants input a command telling parking program 120 to cease navigating to additional parking spots. For example, computing device 110 has a display such as a touchscreen that has an on/off button allowing a vehicle occupant to turn off parking program 120.

FIG. 3 depicts a map schematic, designated 300, illustrating a potential output of parking program 120, on computing device 110 within the environment of FIG. 1, in accordance with an exemplary embodiment of the present invention. In this embodiment, vehicle icon 320 represents the vehicle pulling into parking lot 315 on a hot day. Building 310 casts a shadow by blocking direct sunlight from setting sun 340. The result is that the three parking spots 335, which are completely shaded by building 310 from the sunlight of setting sun 340 have the highest weighting (0.98). Parking spot 330, which is partially shaded from setting sun 340 during the anticipated stay of the vehicle, is given a lower weighting (0.75) by parking program 120. All of the other parking spots, of which parking spots 325 are representative, are not shaded by at all from setting sun 340. Consequently, these parking spots have the lowest weighting (0.40). In this embodiment, the weighting range is from zero (undesirable) to one (most desirable). Since these parking spots are in close proximity and all of the same type (angled), the main distinguishing feature is whether they are in the shade or in the sun during the anticipated stay of the vehicle. FIG. 3 is for illustrative purposes only and is just one of several possible outputs of parking program 120 on device 110.

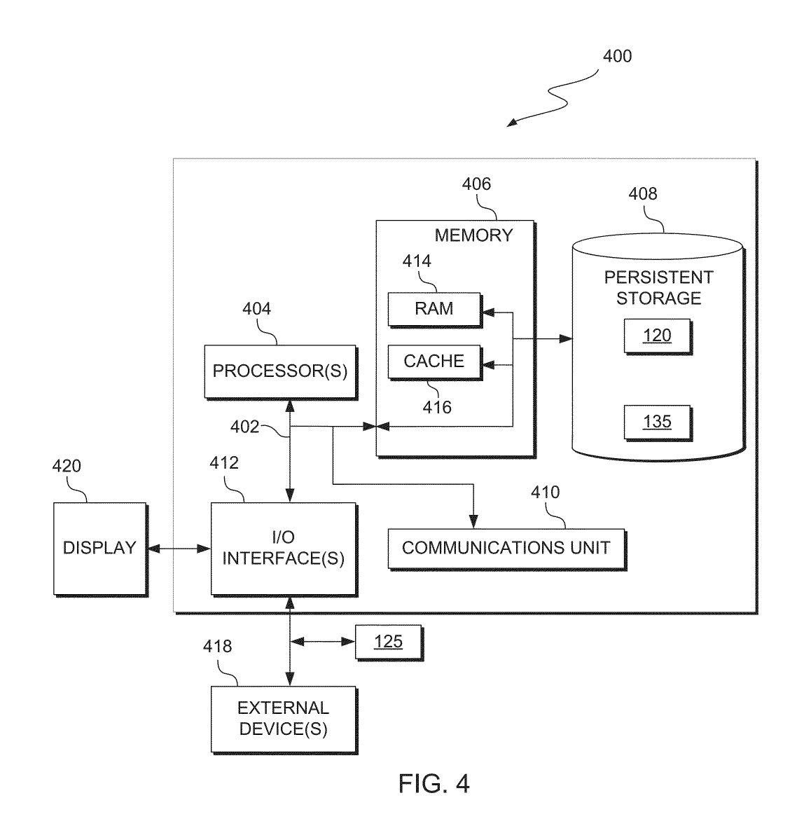

FIG. 4 depicts a block diagram, 400, of components of computing device 110, in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

Computing device 110 includes communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer-readable storage media. In this embodiment, memory 406 includes random access memory (RAM) 414 and cache memory 416. In general, memory 406 can include any suitable volatile or non-volatile computer-readable storage media.

Parking program 120 and geographical database 135 are stored in persistent storage 408 for execution and/or access by one or more of the respective computer processors 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer-readable storage medium that is also part of persistent storage 408.

Communications unit 410, in these examples, provides for communications with other data processing systems or devices, including resources of network 130. In these examples, communications unit 410 includes one or more network interface cards. Communications unit 410 may provide communications through the use of either or both physical and wireless communications links. Parking program 120 and geographical parking database 135 may be downloaded to persistent storage 408 through communications unit 410.

I/O interface(s) 412 allows for input and output of data with other devices that may be connected to computing device 110. For example, I/O interface 412 may provide a connection to GPS receiver 125 and other external devices 418 such as a keyboard, keypad, a touch screen, and/or some other suitable input device. External devices 418 can also include portable computer-readable storage media such as, for example, thumb drives, portable optical or magnetic disks, and memory cards. Software and data used to practice embodiments of the present invention, e.g., parking program 120 and geographical parking database 135, can be stored on such portable computer-readable storage media and can be loaded onto persistent storage 408 via I/O interface(s) 412. I/O interface(s) 412 also connect to a display 420.

Display 420 provides a mechanism to display data to a user and may be, for example, a computer monitor, or a television screen.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

It is to be noted that the term(s) such as “Smalltalk” and GOOGLE and the like may be subject to trademark rights in various jurisdictions throughout the world and are used here only in reference to the products or services properly denominated by the marks to the extent that such trademark rights may exist.

1-7. (canceled)

8. A hardware computer program product for navigating to a parking space comprising:
one or more computer-readable storage media and program instructions stored on at least one of the one or more computer-readable storage media, the program instructions comprising:
program instructions to receive a geographic destination;
program instructions to determine one or more parking spaces within a distance of the geographic destination;
program instructions to assign a ranking order for the one or more parking spaces based on one or more parking criteria, wherein the one or more parking criteria include weighted values that are respectively associated with the one or more parking spaces such that more sunny parking spaces are ranked higher than less sunny parking spaces during cold weather; and
program instructions to provide navigation to the one or more parking spaces, wherein the ranking order for the one or more parking spaces determines an order of arrival at any one parking space of the one or more parking spaces.

9. The computer program product of claim 8 further comprising:
program instructions to determine an estimated time of departure from the geographical destination; and
program instructions to determine an effect the estimated time of departure from the geographical destination will have on the one or more parking criteria.

10. The computer program product of claim 8, wherein the program instructions to assign a ranking order for the one or more parking spaces based on one or more parking criteria further comprises:
program instructions to assign a ranking order for the one or more parking spaces based on one or more considerations including a weather condition, a time of year, and a time of day.

11. The computer program product of claim 8, wherein the program instructions to assign a ranking order for the one or more parking spaces based on one or more parking criteria further comprises:
program instructions to assign a ranking order for the one or more parking spaces based on one or more considerations including a vehicle anticipated internal temperature, a vehicle hygiene, an eligibility of a vehicle to park in a given space, and a size compatibility of the vehicle to the one or more parking spaces.

12. The computer program product of claim 8, wherein the program instructions to assign a ranking order for the one or more parking spaces based on one or more parking criteria further comprises:
program instructions to assign a ranking order for the one or more parking spaces based on one or more considerations including considerations due to a preference of an operator of a vehicle, a parallel parking ability of the operator of the vehicle, one or both of: a vehicle operator profile and a vehicle passenger preference.

13. The computer program product of claim 8, wherein the program instructions to assign a ranking order for the one or more parking spaces based on one or more parking criteria further comprises:
program instructions to assign a ranking order for the one or more parking spaces based on one or more considerations including whether the one or more parking spaces are parallel parking spaces, a vehicle size compatibility of the one or more parking spaces, a degree of lighting of the one or more parking spaces, an amount of time in shade of the one or more parking spaces, and whether a plurality of desirable parking spaces are in close proximity to the one or more parking spaces.

14. The computer program product of claim 8, wherein the program instructions to assign a ranking order for the one or more parking spaces based on one or more parking criteria further comprises:
program instructions to assign a ranking order for the one or more parking spaces based on data from one or more databases including one or more mapping databases and one or more police databases.

15. A computer system for navigating to a parking space comprising:
one or more computer processors;
one or more computer-readable storage media; and
program instructions stored on at least one of the one or more computer-readable storage media, the program instructions comprising:
program instructions to receive a geographic destination;
program instructions to determine one or more parking spaces within a distance of the geographic destination;
program instructions to assign a ranking order for the one or more parking spaces based on one or more parking criteria, wherein the one or more parking criteria include weighted values that are respectively associated with the one or more parking spaces such that more sunny parking spaces are ranked higher than less sunny parking spaces during cold weather; and
program instructions to provide navigation to the one or more parking spaces, wherein the ranking order for the one or more parking spaces determines an order of arrival at any one parking space of the one or more parking spaces.

16. The computer system of claim 15 further comprising:
program instructions to determine an estimated time of departure from the geographical destination; and
program instructions to determine an effect the estimated time of departure from the geographical destination will have on the one or more parking criteria.

17. The computer system of claim 15, wherein the program instructions to assign a ranking order for the one or more parking spaces based on one or more parking criteria further comprises:
program instructions to assign a ranking order for the one or more parking spaces based on one or more considerations including a weather condition, a time of year, and a time of day.

18. The computer system of claim 15, wherein the program instructions to assign a ranking order for the one or more parking spaces based on one or more parking criteria further comprises:
program instructions to assign a ranking order for the one or more parking spaces based on one or more considerations including a vehicle anticipated internal temperature, a vehicle hygiene, an eligibility of a vehicle to park in a given space, and a size compatibility of the vehicle to the one or more parking spaces.

19. The computer system of claim 15, wherein the program instructions to assign a ranking order for the one or more parking spaces based on one or more parking criteria further comprises:
program instructions to assign a ranking order for the one or more parking spaces based on one or more considerations including considerations due to a preference of an operator of a vehicle, a parallel parking ability of the operator of the vehicle, one or both of: a vehicle operator profile and a vehicle passenger preference.

20. The computer system of claim 15, wherein the program instructions to assign a ranking order for the one or more parking spaces based on one or more parking criteria further comprises:
program instructions to assign a ranking order for the one or more parking spaces based on one or more considerations including whether the one or more parking spaces are parallel parking spaces, a vehicle size compatibility of the one or more parking spaces, a degree of lighting of the one or more parking spaces, an amount of time in shade of the one or more parking spaces, and whether a plurality of desirable parking spaces are in close proximity to the one or more parking spaces.
